(19) United States
(12) Patent Application Publication
(10) Pub. No.: US 2026/0289104 A1
(43) Pub. Date: Sep. 24, 2026

(54) SYSTEM AND METHOD FOR GENERATING DROOLS RULE LANGUAGE FROM NATURAL LANGUAGE CONSTRUCTS

(71) Applicant: JPMorgan Chase Bank, N.A., New York, NY (US)

(72) Inventors: Stanislav KOMAROVSKY, Plano, TX (US); Thenmozhi MUTHUSAMY, Short Hills, NJ (US); Kamesh KARRA, Jersey City, NJ (US)

(73) Assignee: JPMorgan Chase Bank, N.A., New York, NY (US)

(21) Appl. No.: 19/084,361

(22) Filed: Mar. 19, 2025

(51) Int. Cl. G06F 40/20

(52) U.S. Cl. CPC G06F 40/20

(57) ABSTRACT

A system and method for generating DRL from natural language is provided. The methodology includes: extracting components from an input natural language constraint including at least a data model attribute, a predefined value, and a category of the natural language constraint; first generating, in response to the at least the extracting and based on the extracted components, a structured constraint; first prompting a user to provide first feedback on the structured constraint; in response to at least receiving a first confirmation instruction responsive to at least the first prompting, identifying for the structured constraint a corresponding DRL template from a repository of recursive templates; populating the DRL template with at least some of the data model attributes and the predefined values as extracted; and second prompting a user to provide second feedback on the complete DRL template.

### TECHNICAL FIELD

This disclosure relates to methods and apparatuses for using an artificial intelligence/machine learning (AI/ML) model to generate a Drools Rule Language (DRL) from natural language constructs.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Keeping up with changing compliance rules is a technical challenge. Legacy systems have high lead time to implement rules for new product launches and rules are not business friendly and are hard to understand and manage, hindering testing and reducing velocity of software development. There are high costs in that legacy systems are expensive to maintain and upgrade. There is complexity by having to manage multiple compliance systems. There is outdated technology in that many of these systems often not equipped to meet modern compliance demands.

Traditional methods to streamline compliance rules are both time-consuming and resource intensive. The interested party first creates the general framework for a rule and submits it to an IT department for creation of a software product that applies the rule. The rule then goes through testing, often failing due to errors in either the original framework or the subsequent software programming. A disconnect between the rule requestor (who understands the business objectives but often is not fluent in software) and the software side (who understand the software but have lesser grasp on the business objectives behind the rule) can easily inhibit deployment of the rule. It is not uncommon for this traditional rule generation process to take weeks or months to complete.

The traditional methods above have several technical problems. A first problem is that the process is highly subjective. When the framework of the rule is first created, the rule is a subjective expression of what the creator wants to happen, but different creators might express the rule differently, such that the software creation side may generate different products that do not operate correctly. The process simply lacks a uniform objective standard. It is also unclear during later testing whether any error was due to the rule framework or the software implementation, and additional testing is required to isolate the source of the error. The constant back and forth, course corrections, and repeated testing consumes a great deal of computer resources, electrical power, and takes a great deal of time.

### SUMMARY

The present disclosure, through one or more of its various aspects, embodiments, and/or specific features or sub-components, provides, among other features, various systems, servers, devices, methods, media, programs, and platforms for using an AI/ML model to generate DRL language from natural language constraints in an accurate and efficient manner.

According to an embodiment, a method for generating DRL from natural language is provided. The method includes: receiving as input a natural language constraint; extracting components from the input natural language constraint including at least a data model attribute, a predefined value, and a category of the natural language constraint; first generating, in response to the at least the extracting and based on the extracted components, a structured constraint that includes an explanation of the extracted components; first prompting a user to provide first feedback on the structured constraint; in response to at least receiving a first correction instruction responsive to at least the first prompting, returning to the extracting with the first correction instruction; in response to at least receiving a first confirmation instruction responsive to at least the first prompting, identifying for the structured constraint a corresponding Drools Rule Language (DRL) template from a repository of recursive templates; second generating a complete DRL template, including populating the DRL template with at least some of the data model attributes and the predefined values as extracted; displaying the complete DRL template; and second prompting a user to provide second feedback on the complete DRL template.

The above embodiment may have various optional features. The method may further include in response to at least receiving a second correction instruction responsive to the second prompting, returning to the extracting with the second correction instruction, and in response to at least receiving a second confirmation instruction responsive to the second prompting, testing the complete DRL template. The first correction instruction may include information about how to change the data model attribute, the predefined value, and/or any examples of usage. The recursive templates may allow for hierarchical inclusion of other templates. The method may include mapping the structured constraint to the identified corresponding DRL template using a language mode. The generating a complete DRL template may include generating a complete DRL template recursively. The displaying the complete DRL template may include displaying an explanation of structure and rationale of components of the DRL template.

According to an embodiment, a system for generating DRL from natural language is provided. The system includes a processor and a memory storing instructions programmed to cooperate with the processor to cause the processor to perform operations. The operations include: receiving as input a natural language constraint; extracting components from the input natural language constraint including at least a data model attribute, a predefined value, and a category of the natural language constraint; first generating, in response to the at least the extracting and based on the extracted components, a structured constraint that includes an explanation of the extracted components; first prompting a user to provide first feedback on the structured constraint; in response to at least receiving a first correction instruction responsive to at least the first prompting, returning to the extracting with the first correction instruction; in response to at least receiving a first confirmation instruction responsive to at least the first prompting, identifying for the structured constraint a corresponding Drools Rule Language (DRL) template from a repository of recursive templates; second generating a complete DRL template, including populating the DRL template with at least some of the data model attributes and the predefined values as extracted; displaying the complete DRL template; and second prompting a user to provide second feedback on the complete DRL template.

The above embodiment may have various optional features. The operations may further include in response to at least receiving a second correction instruction responsive to the second prompting, returning to the extracting with the second correction instruction, and in response to at least receiving a second confirmation instruction responsive to the second prompting, testing the complete DRL template. The first correction instruction may include information about how to change the data model attribute, the predefined value, and/or any examples of usage. The recursive templates may allow for hierarchical inclusion of other templates. The operations may include mapping the structured constraint to the identified corresponding DRL template using a language mode. The generating a complete DRL template may include generating a complete DRL template recursively. The displaying the complete DRL template may include displaying an explanation of structure and rationale of components of the DRL template.

According to an embodiment, a non-transitory computer readable media storing instructions programmed to cooperate with a processor to cause the processor to perform operations is provided. The operations include: receiving as input a natural language constraint; extracting components from the input natural language constraint including at least a data model attribute, a predefined value, and a category of the natural language constraint; first generating, in response to the at least the extracting and based on the extracted components, a structured constraint that includes an explanation of the extracted components; first prompting a user to provide first feedback on the structured constraint; in response to at least receiving a first correction instruction responsive to at least the first prompting, returning to the extracting with the first correction instruction; in response to at least receiving a first confirmation instruction responsive to at least the first prompting, identifying for the structured constraint a corresponding Drools Rule Language (DRL) template from a repository of recursive templates; second generating a complete DRL template, including populating the DRL template with at least some of the data model attributes and the predefined values as extracted; displaying the complete DRL template; and second prompting a user to provide second feedback on the complete DRL template.

The above embodiment may have various optional features. The operations may further include in response to at least receiving a second correction instruction responsive to the second prompting, returning to the extracting with the second correction instruction, and in response to at least receiving a second confirmation instruction responsive to the second prompting, testing the complete DRL template. The first correction instruction may include information about how to change the data model attribute, the predefined value, and/or any examples of usage. The recursive templates may allow for hierarchical inclusion of other templates. The operations may include mapping the structured constraint to the identified corresponding DRL template using a language mode. The generating a complete DRL template may include generating a complete DRL template recursively. The displaying the complete DRL template may include displaying an explanation of structure and rationale of components of the DRL template.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIGS. 4A and 4B illustrates an exemplary flow chart of a process for using an AI/ML model to generate DRL language from natural language constraints in an accurate and efficient manner, in accordance with an embodiment.

FIG. 5 illustrates a model design that corresponds to a process for using an AI/ML model to generate DRL language from natural language constraints in an accurate and efficient manner.

FIG. 6 illustrates a structured constraint, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

The traditional methods of rule generation have several technical problems. A first problem is that the process is highly subjective. When the framework of the rule is first created, the rule is a subjective expression of what the creator wants to happen, but different creators might express the rule differently, such that the software creation side may generate different products that do not operate correctly. The process simply lacks a uniform objective standard. It is also unclear during later testing whether any error was due to the rule framework or the software implementation, and additional testing is required to isolate the source of the error. The constant back and forth, course corrections, and repeated testing consumes a great deal of computer resources, electrical power, and takes a great deal of time.

According to an embodiment, a method for generating DRL from natural language is provided. The method includes: receiving as input a natural language constraint; extracting components from the input natural language constraint including at least a data model attribute, a predefined value, and a category of the natural language constraint; first generating, in response to the at least the extracting and based on the extracted components, a structured constraint that includes an explanation of the extracted components; first prompting a user to provide first feedback on the structured constraint; in response to at least receiving a first correction instruction responsive to at least the first prompting, returning to the extracting with the first correction instruction; in response to at least receiving a first confirmation instruction responsive to at least the first prompting, identifying for the structured constraint a corresponding Drools Rule Language (DRL) template from a repository of recursive templates; second generating a complete DRL template, including populating the DRL template with at least some of the data model attributes and the predefined values as extracted; displaying the complete DRL template; and second prompting a user to provide second feedback on the complete DRL template.

The above methodology provides a technical solution to the technical problems of the traditional methods. First, a user subjective establishment of a framework for a rule is replaced with an objective definition of the rule per both the structured response and the resulting DRL rules. Second, as user intent is confirmed at two points in the processes before testing—one at the structured response stage and the other at the DRL stage—the probability of errors in the testing process is much lower, which reduces the number of tests and corresponding drain on computer resources and electrical power. Third, the process takes only a fraction of time, in what took weeks or months to software develop the rule can now be performed in hours. By incorporating business-specific insights through Retrieval-Augmented Generation, Reciprocal Rank Fusion, and Cross Model Re-ranking, the methodology can generate rules that are not only technically correct but also aligned with the strategic objectives and compliance needs of the business.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

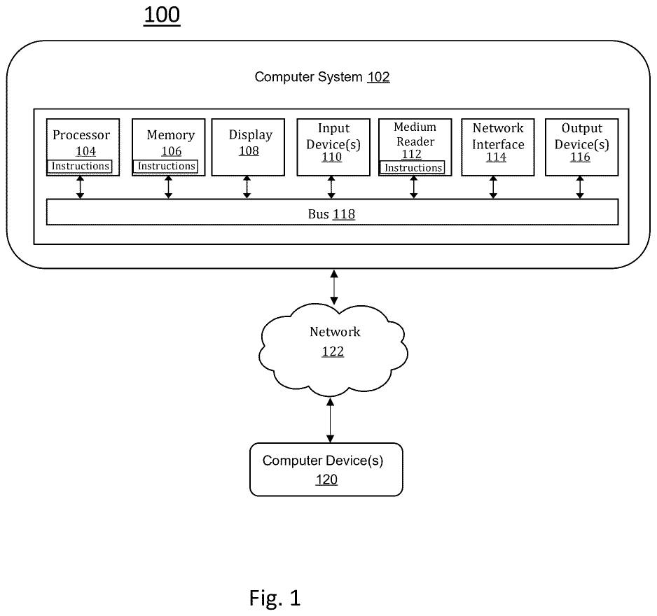

FIG. 1 is an exemplary system 100 for use in implementing a method for using an AI/ML model to generate DRL language from natural language constraints in an accurate and efficient manner, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

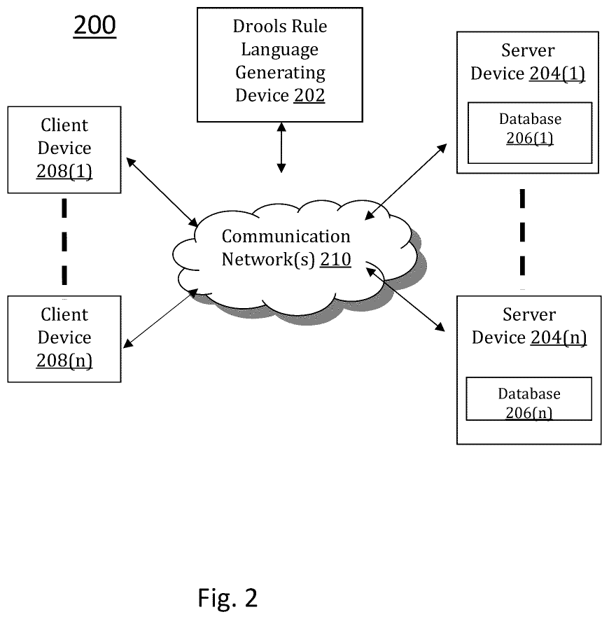

Referring to FIG. 2, a schematic of an exemplary network environment 200 for implementing DRL generating device (DRLGD) of the instant disclosure is illustrated.

In some embodiments, the above-described problems associated with conventional tools may be overcome by implementing an DRLGD 202 as illustrated in FIG. 2 that may be configured for implementing a method for using an AI/ML model to generate DRL language from natural language constraints in an accurate and efficient manner, but the disclosure is not limited thereto.

The DRLGD 202 may have one or more computer system 102s, as described with respect to FIG. 1, which in aggregate provide the necessary functions.

The DRLGD 202 may store one or more applications that can include executable instructions that, when executed by the DRLGD 202, cause the DRLGD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DRLGD 202 itself, may be located in virtual server(s) running in a cloud-based computing environment rather than being tied to one or more specific physical network computing devices. Also, the application(s) may be running in one or more virtual machines (VMs) executing on the DRLGD 202. Additionally, in one or more embodiments of this technology, virtual machine(s) running on the DRLGD 202 may be managed or supervised by a hypervisor.

In the network environment 200 of FIG. 2, the DRLGD 202 is coupled to a plurality of server devices 204(1)-204(n) that hosts a plurality of databases 206(1)-206(n), and also to a plurality of client devices 208(1)-208(n) via communication network(s) 210. A communication interface of the DRLGD 202, such as the network interface 114 of the computer system 102 of FIG. 1, operatively couples and communicates between the DRLGD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DRLGD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DRLGD 202 may be a standalone device or integrated with one or more other devices or apparatuses, such as one or more of the server devices 204(1)-204(n), for example. In one particular example, the DRLGD 202 may be hosted by one of the server devices 204(1)-204(n), and other arrangements are also possible. Moreover, one or more of the devices of the DRLGD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DRLGD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the DRLGD 202 that may efficiently provide a platform for implementing a method for using an AI/ML model generate DRL language from natural language constraints in an accurate and efficient manner, but the disclosure is not limited thereto.

The client devices 208(1)-208(n) may run interface applications, such as standard web browsers or standalone client applications, which may provide an interface to communicate with the DRLGD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the DRLGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the DRLGD 202, the server devices 204(1)-204(n), or the client devices 208(1)-208(n), for example, may be configured to operate as virtual instances on the same physical machine. For example, one or more of the DRLGD 202, the server devices 204(1)-204(n), or the client devices 208(1)-208(n) may operate on the same physical device rather than as separate devices communicating through communication network(s) 210. Additionally, there may be more or fewer DRLGDs 202, server devices 204(1)-204(n), or client devices 208(1)-208(n) than illustrated in FIG. 2. In some embodiments, the DRLGD 202 may be configured to send code at run-time to remote server devices 204(1)-204(n), but the disclosure is not limited thereto.

The AI/ML/LLM may itself be an internal or an external server. The LLM may be trained, fine-tuned, or a generic model supporting Drools DRL and general programming languages.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

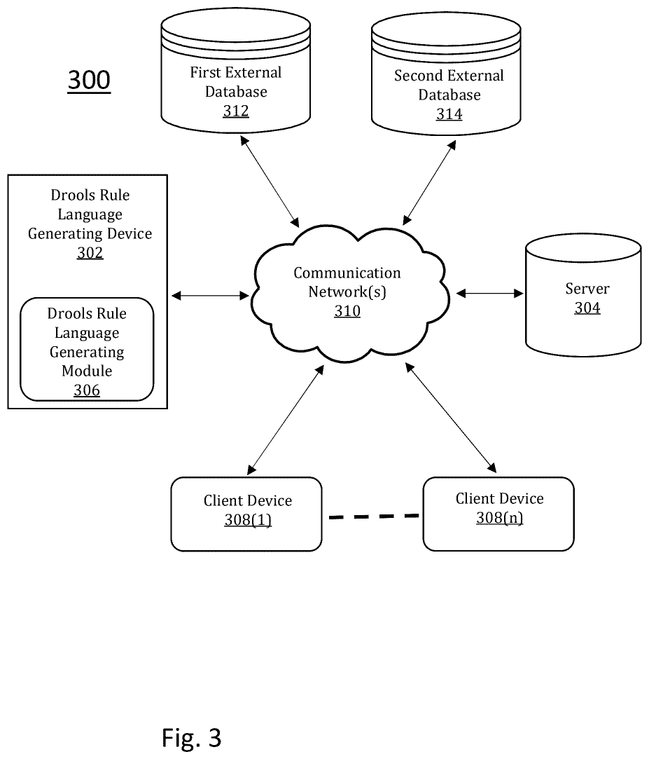

FIG. 3 illustrates a system diagram for implementing an DRLGD 302 having an DRL Generator module (DRLGM), in accordance with an embodiment.

As illustrated in FIG. 3, the system 300 may include an DRLGD 302 within which an DRLGM 306 is embedded, a server 304, a first external database 312, a second external database 314, a plurality of client devices 308(1) . . . 308(n), and a communication network 310.

In some embodiments, the DRLGD 302 including the DRLGM 306 may be connected to the server 304, and the database(s) 312 via the communication network 310. The DRLGD 302 may also be connected to the plurality of client devices 308(1) . . . 308(n) via the communication network 310, but the disclosure is not limited thereto.

In an embodiment, the DRLGD 302 is described and shown in FIG. 3 as including the DRLGM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the DRLGM 306 may be configured to receive real-time feed of data from the plurality of client devices 308(1) . . . 308(n) and secondary sources via the communication network 310.

The plurality of client devices 308(1) . . . 308(n) are illustrated as being in communication with the DRLGD 302. In this regard, the plurality of client devices 308(1) . . . 308(n) may be “clients” (e.g., customers) of the DRLGD 302 and are described herein as such. Nevertheless, it is to be known and understood that the plurality of client devices 308(1) . . . 308(n) need not necessarily be “clients” of the DRLGD 302, or any entity described in association therewith herein. Any additional or alternative relationship may exist between either or both of the plurality of client devices 308(1) . . . 308(n) and the DRLGD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the DRLGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The DRLGD 302 may be the same or similar to the DRLGD 202 as described with respect to FIG. 2, including any features or combination of features described with respect thereto.

The external databases 312 and 314 or server 304, and/or other components, may include a business-specific knowledgebase implemented using Retrieval-Augmented Generation (RAG) techniques. This knowledgebase allows for tailoring rule generation to specific business contexts. The RAG enhances the system's ability to understand and process business-specific constraints and requirements by integrating information from various sources, ensuring that the generated rules align with the unique needs of the business.

The external databases 312 and 314 or server 304, and/or other components, may include semantic and BM-25 databases. Semantic databases capture the meaning and context of business terms and constraints, allowing the system to interpret natural language inputs accurately. BM-25 databases allow for efficient information retrieval, helping to rank and retrieve the most relevant business rules and examples.

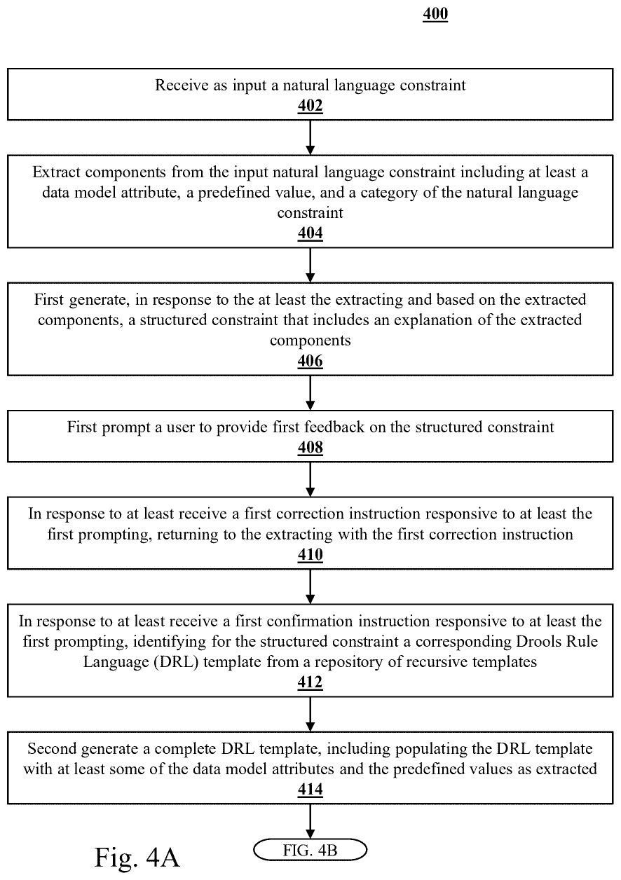

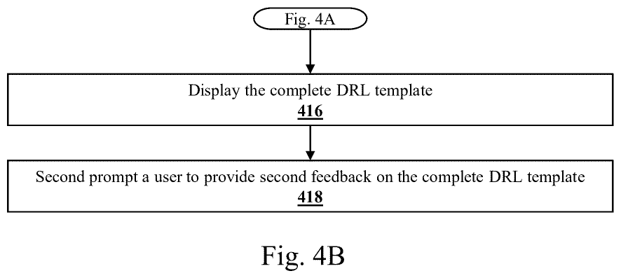

FIGS. 4A and 4B illustrate an exemplary flow chart of a process 400 implemented by the DRLGM 306 of FIG. 3 for enablement of a system and a method for using an AI/ML model to generate DRL language from natural language constraints in an accurate and efficient manner, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIGS. 4A and 4B, at step 402, the process 400 may include receiving as input a natural language constraint, representing the user's input of the desired rule to be created.

At the step 404, the process 400 may include extracting components from the input natural language constraint including at least a data model attribute, a predefined value, and a category of the natural language constraint. The results generate a prompt for an AI/ML to generate structured constraints.

At step 406, the process 400 may include first generating, in response to the at least the extracting and based on the extracted components, a structured constraint that includes an explanation of the extracted components.

At step 408, the process 400 may include first prompting a user to provide first feedback on the structured constraint.

At step 410, the process 400 may include in response to at least receiving a first correction instruction responsive to at least the first prompting, returning to the extracting with the first correction instruction.

At step 412, the process 400 may include in response to at least receiving a first confirmation instruction responsive to at least the first prompting, identifying for the structured constraint a corresponding DRL template from a repository of recursive templates.

At step 414, the process 400 may include second generating a complete DRL template, including populating the DRL template with at least some of the data model attributes and the predefined values as extracted.

At step 416, the process may include displaying the complete DRL template.

At step 418, the process may include second prompting a user to provide second feedback on the complete DRL template.

The above methodology provides a technical solution to the technical problems of the traditional methods. First, a user's subjective establishment of a framework for a rule is replaced with an objective definition of the rule per both the structured response and the resulting DRL rules. Second, as user intent is confirmed at two points in the processes before testing—one at the structured response stage and the other at the DRL stage—the probability of errors in the testing process is much lower, which reduces the number of tests and corresponding drain on computer resources and electrical power. Third, the process takes only a fraction of time, in what took weeks or months to software develop the rule can now be performed in hours.

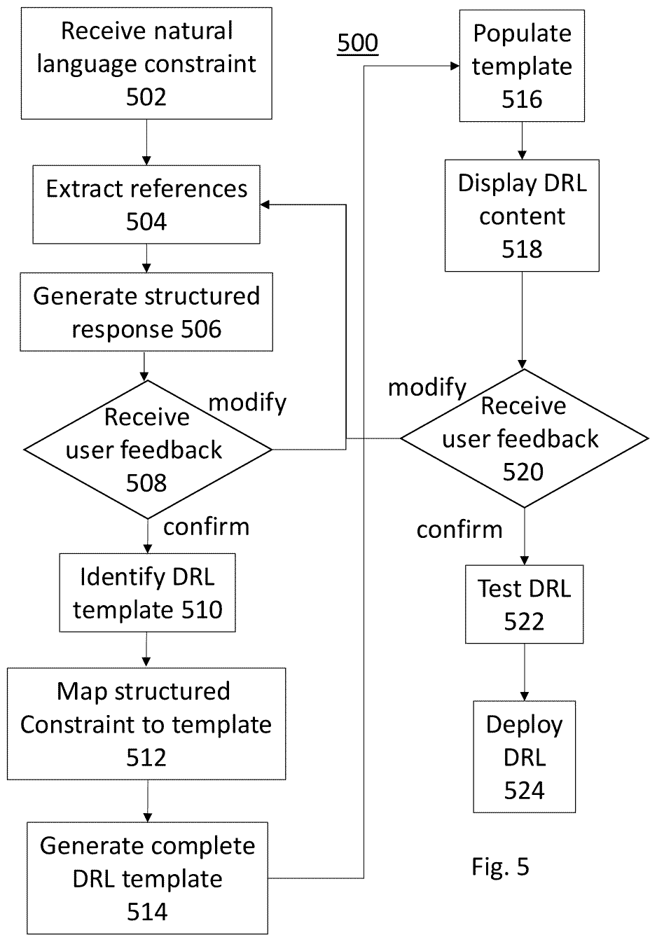

FIG. 5 shows a workflow 500 to generate DRL language in accordance with an embodiment.

At step 502 the system receives a natural language constraint input from the user via a user interface to capture input. The purpose is to gather the initial constraint that the user wishes to convert into a compliance rule.

At step 504, the AI/ML analyzes the natural language input to identify keywords with references to data model attributes and any predefined values using natural language processing (NLP) techniques to parse and understand the input. The purpose is to extract relevant information needed for an AI/ML prompt for rule generation. The methodology accesses a BM-25 database to identify which keywords appear most frequently in relevant database. The methodology may also access a semantic database that captures the meaning and context of business terms and constraints, allowing the system to interpret natural language inputs accurately.

Both the results of the semantic and B-25 database inquiries may be subject to Reciprocal Rank Fusion (RRF) to combine results from semantic and BM-25 databases. RRF is used to aggregate the rankings from both sources, ensuring that the most relevant information can be prioritized. Cross Model Re-ranking (CMR) can be used to further refine the results output from RRF by applying additional predetermined criteria to re-rank the results based on their relevance and alignment with business objectives. These techniques enable the methodology to achieve a deep understanding of business-specific requirements, which is valuable for generating accurate and effective Drools Rule Language.

The results post-ranking are used to generate a structured constraint prompt with the most relevant information prioritized for the AI/ML to seek appropriate structured constraints in response.

At step 506, the AI/ML generates and displays a structured constraint response, explaining the extracted elements and the system's understanding of the constraint. The methodology uses NLP and/or AI models as pre-trained to create a coherent explanation. A purpose is to provide feedback to the user and ensure accurate interpretation of the input.

The structured response achieves two related objectives. A first is that the natural language has been converted into a form that can later be converted into DRL rules.

A second is that the structured response provides a first review opportunity for the user that does not yet involve conversion of the business rule into software code. The structured response is thus an intermediary state of the transformation process to confirm the structured response is accurate or request further changes before resources are expended to convert the rule into software to undergo further testing.

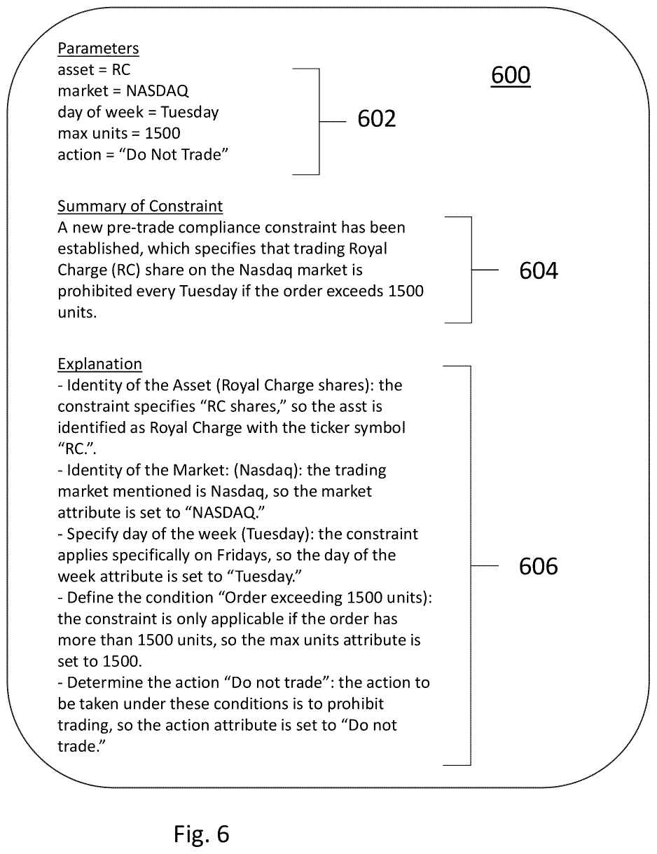

A non-limiting example of structured response 600 is shown in FIG. 6 for a natural language constraint of “Cannot liquidate more than 1500 shares of RC on NASDAQ stock on Tuesdays”.

The structured response may include a first field section 602, in which the structural parameters are established. For the above example, this includes: asset=RC, market=NASDAQ, day of week=Tuesday, max units=1500, and action=“Do Not Trade”.

The structured response may include a second field section 604, which provides a summary of the rule: “A new pre-trade compliance constraint has been established, which specifies that trading Royal Charge (RC) share on the Nasdaq market is prohibited every Tuesday if the order exceeds 1500 units.”

The structured response may include a third field section 606, which provides an explanation of the rules. Explanations for the above example may include:

Identity of the Asset (Royal Charge shares): the constraint specifies “RC shares,” so the asset is identified as Royal Charge with the ticker symbol “RC.”.

Identity of the Market: (Nasdaq): the trading market mentioned is Nasdaq, so the market attribute is set to “NASDAQ.”

Specify day of the week (Tuesday): the constraint applies specifically on Fridays, so the day of the week attribute is set to “Tuesday.”

Define the condition “Order exceeding 1500 units): the constraint is only applicable if the order has more than 1500 units, so the max units attribute is set to 1500.

Determine the action “Do not trade”: the action to be taken under these conditions is to prohibit trading, so the action attribute is set to “Do not trade.”

Returning now to FIG. 5, at step 508, the methodology prompts for and can receive user feedback on the structured response. One form of feedback would be a confirmation instruction, in which the user confirms that the structured response reflects the user intent. Another form of feedback would be an explanation request, in which the user provides a natural language statement requesting further explanation of some terms, which the methodology could respond as a sub step within 508. Another form of feedback would be a correction instruction, in which the user can provide a natural language statement on how the structured response differs from the user's intent. Yet another form of feedback would be a request for recommendation instruction, in which the user enters a natural language request for advice or information on how to proceed next or make certain modifications.

The prompt for feedback may take any form. A non-limiting example is simple inquiry of “what would you like to do next” with a field that the user can populate with a confirmation instruction (e.g., “this is acceptable” or “proceed with this response”), a correction instruction (“change Tuesday to Friday”), or explanation request (“what is RC”?).

If the correction instruction is received, then control returns to step 506 (or potentially 504 for further extraction) where the system uses the natural language statement from 508 to generate a new structured constraint. This cycle can occur iteratively until the system receives a confirmation instruction.

By way of example relative to FIG. 6, the user may observe that the rule is wrong or incomplete, such as the share limit should be 1200 or the prohibition date should be the last Tuesday of the month. The methodology would generate a new structured response, replacing 1500 shares with 1200 shares, and adding a new parameter of Week of month=last week.

When the methodology receives a confirmation instruction (which represents that the user is satisfied with the structured response), at step 510 the AI/ML identifies an appropriate DRL template from a repository that matches the structured constraint. By way of non-limiting example, for a “Cannot liquidate more than 1500 shares of RC on NASDAQ stock on Tuesdays” natural language input above, the methodology would locate an appropriate block trading DRL template.

At step 512, the AI/ML maps the structured response to the identified DRL template to align the response with the template structure.

At step 514, the AI/ML recursively generates a complete DRL template. This process establishes the rules structure of the DRL template. By way of non-limiting example, for the “Cannot liquidate more than 1500 shares of RC on NASDAQ stock on Tuesdays” structured response above, this step could generate a complete DRL template for blocking trading of a stock on a certain day above a certain number of shares.

Also at step 514, the AI/ML may identify that the template requires more information that provided in the natural language constraint or the structured constraint response. The AI/ML may obtain that information from other databases or generate a prompt for the user to provide the missing information.

At step 516, the AI/ML populates the complete DRL template with the data references. These data references may be drawn from the structured parameters included in the structured response generated at 506 above, or as obtained by the AI/ML at 514. By way of non-limiting example, “Cannot liquidate more than 1500 shares of RC on NASDAQ stock on Tuesdays” could result in population of name=RC, shares=1500, date=Tuesday, etc.

At step 518, the AI/ML presents/displays the generated DRL rules to the user on a user interface, along with a detailed explanation of the rules. This allows the user to review and understand the generated rule.

At step 520, the methodology can receive user feedback on the DRL rules. One form of feedback would be a confirmation instruction, in which the user confirms that the DRL rules reflects the user intent. Another form of feedback would be an explanation request, in which the user provides a natural language statement requesting further explanation of some terms, which the methodology could respond as a sub step within 520. Another form of feedback would be a correction instruction, in which the user can input a natural language statement on how the DRL rules differs from the user's intent. Yet another form of feedback would be a request for recommendation instruction, in which the user enters a natural language request for advice or information on how to proceed next or make certain modifications.

If the correction instruction is received, then control returns to step 506 (or potentially 504 for further extraction) where the methodology uses the natural language statement from 508 to generate a new structured constraint. This cycle can occur iteratively until the system receives a confirmation instruction.

When the methodology receives a confirmation instruction (which represents that the user is satisfied with the DRL rules), at step 522 the methodology tests the DRL rules to confirm that they operate as intended. Upon completion of successful testing, at step 524 the DRL rules are deployed.

By incorporating business-specific insights through RAG, RRF, and CMR, the system can generate rules that are not only technically correct but also aligned with the strategic objectives and compliance needs of the business. This capability sets the system apart from generic rule generation tools. The probability of errors in the testing process is much lower, which reduces the number of tests and corresponding drain on computer resources and electrical power.

Below is a list of non-limiting examples of natural language constraints:
SECTOR_RESTRICTIONS_NO_BUY_SELL_2.0: Orders involving security subtypes like mutual funds, hedge funds, ETFs, equities, and fixed income cannot proceed if there are client restrictions on both buying and selling within specified industry categories.
COUNTRY_RESTRICTIONS_NO_BUY_2.0: For investment management accounts, buying securities from countries like the USA, UK, or Germany is restricted if the client's restrictions include those countries.
COUNTRY_RESTRICTIONS_NO_SELL_2.0: Selling or closing out securities from countries such as France, Italy, or Japan is restricted for investment management accounts if the client's restrictions include those countries.
LEGAL_BANNED_NO_TRADE_2.0: Trading is prohibited for securities like ETFs, equities, and fixed income that are on a banned list, regardless of whether the action is buying or selling.
LEGAL_RESTRICTED_NON_ETF_NO_BUY_2.0: Buying non-ETF securities like equities and fixed income is restricted if they are on a restricted list and match identifiers like ISIN or CUSIP.
DO_NOT_TRADE_MF_ETF_PBA_2.0: Trading mutual funds and ETFs on the USA platform is restricted if they do not meet client restrictions and are not money market funds.
LEGAL_RESTRICTED_PBA_ETF_NO_BUY_2.0: Buying ETFs on the USA platform is restricted if they are on a restricted list and the account does not have investment objectives like “D1” or “D3”.
BLOCKED_SECURITY_FOREIGN_OWNERSHIP_2.0: Trading is blocked for securities with ISIN “IE00BYTBXV33” due to foreign ownership restrictions.
LEGAL_RESTRICTED_PBA_ETF_PRIV_PROD_NO_BUY_2.0: Buying ETFs on the USA platform is restricted for accounts with investment objectives “D1” or “D3” if the ETFs are on a restricted list.
LEGAL_RESTRICTED_PBA_ETF_PRIV_PROD_NO_SELL_2.0: Selling ETFs on the USA platform is restricted for accounts with investment objectives “D1” or “D3” if the ETFs are on a restricted list.
LEGAL_RESTRICTED_NON_ETF_NO_SELL_2.0: Selling non-ETF securities like equities and fixed income is restricted if they are on a restricted list and match identifiers like ISIN or CUSIP.
LEGAL_RESTRICTED_PBA_ETF_NO_SELL_2.0: Selling ETFs on the USA platform is restricted if they are on a restricted list and the account does not have investment objectives like “D1” or “D3”.
BLOCKED_SECURITY_2.0: Trading is blocked for securities with a “BLOCKED” status on platforms like CDG, FRA, or NYC.
FIDUCIARY_DIRECTED_ACCT_2.0: Orders from fiduciary-directed accounts on the USA platform are subject to restrictions if the account category is “FIDDTNM” or “FIDMDR” with investment authorization “L”.
CWF_MUST_SEE_NOTES_2.0: Orders require review if the account has more than zero notes that must be seen.
SIX_CIRCLES_RISK_PROFILE_FOR_EQUITY_2.0: Buying mutual funds is restricted if the account's investment objective is not “A4” or “B6” and the fund's risk profile is “E7”, “E8”, or “E9”.
SIX_CIRCLES_RISK_PROFILE_FOR_NON_EQUITY_2.0: Buying mutual funds is restricted if the account's investment objective is “A4” or “B6” and the fund's risk profile is not “CMEUX” or “CMIUX”.
SIX_CIRCLES_TAX_PROFILE_2.0: Buying mutual funds is restricted if the account's investment objective does not contain “AGGREGATE” and the fund's tax profile is “Tax-Exempt Core”.
MF_NO_AGREEMENT_MADRID_2.0: Trading mutual funds is restricted in Madrid if there is no legal agreement like “IM Only Agreement” or “Global Intermediary Agreement”.
INDIVIDUAL_SECURITY_RESTR_NO_BUY_2.0: Buying securities with ISIN, CUSIP, or Valoren is restricted if they are listed in the client's restrictions.
INDIVIDUAL_SECURITY_RESTR_NO_SELL_2.0: Selling securities with ISIN, CUSIP, or Valoren is restricted if they are listed in the client's restrictions.
DO_NOT_TRADE_MF_ETF_IPB_2.0: Trading mutual funds and ETFs on international platforms is restricted if they do not meet client restrictions and are not liquidity funds.
PREVENT_TAXABLE_TAXEXEMPT_BUY_2.0: Buying tax-exempt securities is restricted if the account's investment objective contains “AGGREGATE” and the security is “US Fixed Income”.
PREVENT_FID_NY_PROP_MMF_2.0: Buying proprietary money market funds is restricted for fiduciary accounts in New York with account categories like “FIDMSOA” or “FIDMDR”.
PREVENT_NON_ESG_FUND_IPB_2.0: Buying non-ESG funds is restricted if the account is ESG eligible and the fund's ESG identifier is false.
INDIVIDUAL_SECURITY_RESTR_NO_BUY_SELL_2.0: Buying or selling securities with ISIN, CUSIP, or Valoren is restricted if they are listed in the client's restrictions.
HEADSHEETS_PMG_TEAM_2.0: Orders require review if the account is managed by a PMG team with a specific ID and name.
PREVENT_FID_TAX_PROP_MMF_2.0: Buying proprietary money market funds is restricted for fiduciary accounts with tax service codes like “I”, “J”, or “M”.
PREVENT_FID_IRA_PROP_MMF_2.0: Buying proprietary money market funds is restricted for fiduciary accounts that are not “IRAM” or “ERISAD”.
PREVENT_SIX_CIRCLES_PURCHASE_2.0: Buying mutual funds is restricted if they are not approved for the client's restrictions and are “SIXC”.
MF_CLOSED_FOR_PURCHASE_IPB_CLOSED_2.0: Trading is restricted for mutual funds with a status of “Closed hard”.
SPANISH_CLIENTS_ON_NON_UCITS_2.0: Trading is restricted for Spanish clients on non-UCITS compliant funds if the account center code is 812, 822, 832, 852, or 862.
FUND_STATUS_EMPTY_2.0: Trading is restricted for mutual funds with an empty status unless the account product code is “FSMA2” and the fund security type is ETF.
FRA_PREVENT_NON_TRANSPARENT_INFO_2.0: Trading is restricted for German accounts if the security is tax transparent and the account domicile is “GERMANY”.
MF_CLOSED_FOR_PURCHASE_PBA_2.0: Trading is restricted for mutual funds with a status of “Closed”, “Terminated”, or “Under Review”.
APPROVED_FOR_DMAS_2.0: Trading is restricted for mutual funds not approved for DMAS accounts if the product code is “DMAS2”.
FUND_MADRID_DISTRIBUTOR_2.0: Trading is restricted for mutual funds in Madrid if distribution is not authorized and the center code is 812, 822, 832, 852, or 862.
APRVD_FOR_INDX_ORTED_MND_IPB_MF_ETF_2.0: Trading is restricted for mutual funds and ETFs not approved for index-oriented mandates if the security class code is not in the specified list.
PREVENT_BUY_NON_SMM_SECURITIES_2.0: Buying non-SMM securities is restricted if they are not part of the account's model and the model type is “FUND”.
APRVD_FOR_INDX_ORTED_MND_IPB_EQ_FI_STRATEGY_CHECK_2.0: Trading is restricted for accounts with index-oriented mandates if the product admin is not index-oriented.
FUND_NON_UCITS_COMPLIANT_2.0: Trading is restricted for non-UCITS compliant funds.
TMM_TARGET_LINK_2.0: Trading is restricted if the security is not part of the account's model constituents.
HOLD_FOR_BOOK_BUILDING_2.0: Trading is restricted for securities on hold for book building if the hold type is “ALL”, “BUY”, or “SEL”.
IM_FEE_STRUCTURE_EQFI_2.0: Trading is restricted if the account's fee structure is not “IMS” and the security asset type is “SECURITY”.
APRVD_FOR_INVOBJ_INDX_ORTED_MF_ETF_PBA_2.0: Trading is restricted for mutual funds and ETFs not approved for index-oriented investment objectives if the investment objective code is “Z8”.
PREVENT_LEV_LOAN_ON_LIFE_ACTS_2.0: Trading is restricted for leveraged loans on life accounts.
FUND_EU_LISTING_2.0: Trading is restricted for funds not listed on approved European exchanges like “EURONEXT BRUSSELS” or “LONDON STOCK EXCHANGE GROUP”.
MF_NOT_AUTHORIZED_2.0: Trading is restricted for mutual funds not authorized in registration countries like “−1” or “−2”.
FUND_LOB_NOT_APPROVED_IM_2.0: Trading is restricted for mutual funds not approved for the line of business if the model name does not start with “AP-TAP”.
MMF_SEC_FEE_BUY_2.0: Buying is restricted for money market funds with a liquidity fee indicator during specific dates if the fund is not offshore.
FUND_LOB_NOT_APPROVED_TAP_2.0: Trading is restricted for mutual funds not approved for the TAP line of business if the model name starts with “AP-TAP”.
MMF_SEC_FEE_SELL_2.0: Selling is restricted for money market funds with a liquidity fee indicator during specific dates if the fund is not offshore.
NON_ACTIVE_WORKING_LIST_EQ_2.0: Trading is restricted for securities not on the active equity list.
MMF_SEC_GATE_BUY_2.0: Buying is restricted for money market funds with a redemption gate indicator during specific dates if the fund is not offshore.
MMF_SEC_GATE_SELL_2.0: Selling is restricted for money market funds with a redemption gate indicator during specific dates if the fund is not offshore.
PREVENT_NON_ESG_FUND_PBA_2.0: Trading is restricted for non-ESG funds if the account is ESG eligible and the fund's ESG identifier is false.
MF_ON_PROBATION_IPB_2.0: Trading is restricted for mutual funds on probation.
MF_ETF_NOT_IN_FOCUS_LIST_INFO_2.0: Trading is restricted for mutual funds and ETFs not in the focus list if the account subtype is not “GAP”.
IRA_TAX_EXEMPT_IRA_2.0: Trading is restricted for tax-exempt securities in IRAs with tax service codes like “I”, “J”, or “M”.
IRA_TAX_EXEMPT_ERISA_2.0: Trading is restricted for tax-exempt securities in ERISA accounts with tax service codes like “K” or “P”.
LEGAL_BANNED_NO_TRADE_2.0: Trading is prohibited for securities on a banned list.
COUNTRY_RESTRICTIONS_ONLY_BUY_2.0: Buying is restricted for securities from countries like the USA or UK if the client's restrictions allow only buying.
LEGAL_RESTRICTED_INTL_ETF_NO_BUY_2.0: Buying international ETFs is restricted if they are on a restricted list and the account product code is not “DMAS2” or “ADV2”.
LEGAL_RESTRICTED_INTL_ETF_PRIV_PROD_NO_BUY_2.0: Buying international ETFs is restricted for accounts with product codes “DMAS2” or “ADV2” if the ETFs are on a restricted list.
CHECK_REG_S_RESTRICT_US_PERS_2.0: Buying is restricted for US persons if the security is regulatory restricted and the account domicile is “UNITED STATES OF AMERICA”.
SIX_CIRCLES_TAX_PROFILE_MUNI_2.0: Buying is restricted for mutual funds if the account's investment objective contains “MUNI” and the fund's tax profile is “Taxable Core”.
UCITS_NOT_REG_MF_ETF_2.0: Trading is restricted for UCITS-compliant funds not registered in Germany.
LEGAL_RESTRICTED_INTL_ETF_NO_SELL_2.0: Selling international ETFs is restricted if they are on a restricted list and the account product code is not “DMAS2” or “ADV2”.
LEGAL_RESTRICTED_INTL_ETF_PRIV_PROD_NO_SELL_2.0: Selling international ETFs is restricted for accounts with product codes “DMAS2” or “ADV2” if the ETFs are on a restricted list.
COUNTRY_RESTRICTIONS_ONLY_SELL_2.0: Selling is restricted for securities from countries like France or Japan if the client's restrictions allow only selling.
DO_NOT_TRADE_MF_STATUS_2.0: Trading is restricted for mutual funds with a “Do Not Trade” status.
COUNTRY_RESTRICTIONS_ONLY_SELL_2.0: Selling is restricted for securities from countries like France or Japan if the client's restrictions allow only selling.
MF_NOT_REGISTERED_MADRID_2.0: Trading is restricted for mutual funds not registered in Madrid if the center code is 812, 822, 832, or 862.
NO_BUY_UKRS_RESTRICTION_2.0: Buying is restricted for UK residents if the mutual fund is not eligible for UK residents and the account's UKRND status is “CAPGAIN” or “UNKNOWN”.
MMF_FUND_DESIGNATION_NOT_AVAILABLE_2.0: Trading is restricted for money market funds with an unknown designation code if the account's designation code is “INS” or “UNKNOWN”.
ALR_DO_NOT_SELL_ASSETS_2.0: Selling is restricted for accounts with a restriction on selling assets if the account level restriction is true.
APPROVED_FOR_ACCT_TYPE_PBA_2.0: Trading is restricted for mutual funds not approved for the account type if the account subtype is not eligible.
SECTOR_RESTRICTIONS_NO_BUY_2.0: Buying is restricted for securities in industry categories like technology or healthcare if the client's restrictions include those categories.
SECTOR_RESTRICTIONS_NO_SELL_2.0: Selling is restricted for securities in industry categories like finance or energy if the client's restrictions include those categories.
PREVENT_INVST_MEXICO_SIC_2.0: Trading is restricted for securities on the Mexico Stock Exchange if the account's product admin variant code is not “3.296.1”.
PREVENT_INST_ACC_FOR_RETAIL_MMF_2.0: Trading is restricted for retail money market funds if the account's designation code is “UNKNOWN” or “INS”.

Below is a list of non-limiting examples of data model attributes:
facts:
   Order:
      type: object
      properties:
         orderId:
         type: string
         description: Unique identifier for the order
         example: “MAPI_PROCESS_12734181_2518301_BUY_241014092425”
         activityId:
         type: string
         description: Identifier for the activity associated with the order
         nullable: true
         activitySourceSystem:
         type: string
         description: Source system of the activity
         nullable: true
         platform:
         type: string
         description: Platform where the order was placed
         example: “USA”
         package: net.jpmchase.mapi.core.model.Platform
         orderSide:
         type: string
         description: Side of the order, either BUY or SELL
         example: “BUY”
         quantity:
         type: number
         format: double
         description: Quantity of the order
         example: 561.66
         marketValue:
         type: number
         format: double
         description: Market value of the order
         example: 6695.0
         unitType:
         type: string
         description: Type of unit for the order, e.g., AMOUNT
         example: “AMOUNT”
         orderPrice:
         type: number
         format: double
         description: Price per unit of the order
         example: 11.92
         tradeDate:
         type: string
         format: date
         description: Date when the trade was executed
         example: “2024-10-14”
         settlementDate:
         type: string
         format: date
         description: Date when the trade will be settled
         nullable: true
         dealType:
         type: string
         description: Type of deal
         nullable: true
         securityId:
         type: string
         description: Identifier for the security
         example: “83002G405”
         valoren:
         type: string
         description: Valoren number for the security
         example: “2518301_000”
         security:
         $ref: ‘#/schemas/Security’
         package: net.jpmchase.mapi.securityreference.model.PtcSecurity
         instrument:
         $ref: ‘#/schemas/Instrument’
         package: net. jpmchase. facts. model. Instrument
         nullable: true
         account:
         $ref: ‘#/schemas/Account’
         package: net.jpmchase.mapi.targetportfolio.model.PtcAccount
         position:
         $ref: ‘#/schemas/Position’
         package: net.jpmchase.facts.model.Position
         nullable: true
         tradeHolidays:
         type: array
         description: Trade holidays affecting the order
         items:
         type: string
         format: date-time
         nullable: true
         region:
         type: string
         description: Region where the order was placed
         example: “PBA”
         package: net.jpmchase.mapi.core.model.Region
         enableDebug:
         type: boolean
         description: Flag to enable debug mode
         nullable: true
         roiFailed:
         type: boolean
         description: Flag indicating if ROI failed
         example: false
         gvaAlrFailed:
         type: boolean
         description: Flag indicating if GVA ALR failed
         example: false
         alertExclusionStatus:
         type: boolean
         description: Flag indicating if alert exclusion status is active
         example: false
         accountNumber:
         type: string
         description: Account number associated with the order
         example: “F88647006”
         mandateId:
         type: string
         description: Mandate ID associated with the order
         nullable: true
         productAdmin:
         $ref: ‘#/schemas/PtcGstpTradeAdminData’.

Below is a list of non-limiting examples of pre-defined values:
AccountCategory:
   description: ‘*IM: IM account type * SDI: SDI account type * FIDDTNM: Directed
      Trust Non Managed account type * FIDMSOA: Managed Sole T&E Agent for Fiduciary
      account type * FIDMDR: Managed Sole & Shared Document Restriction account type
         * GAP: GAP account type * IRAM: IRA Discretionary account type * ERISAM: ERISA
      Discretionary account type′
   value:
   UNKNOWN
   IRAM
   ERISAM
   IM
   FIDMSOA
   FIDDTNM
   FIDMDR
   GAP
   type: string
AccountIndicator:
   description: “AccountIndicator
* ‘UNKNOWN’—is for forward compatibility
   * ONSHORE (Onshore Accounts) * OFFSHORE (Offshore Accounts) * POD *
   ACCESS (accounts managing ucits fund) * 23A (23A regulated account)
   INSURANCE * UCITS (accounts managing ucits fund)″
   value:
   UNKNOWN
   ONSHORE
   OFFSHORE
   POD
   ACCESS
   23A
   INSURANCE
   UCITS
   type: string
AccountMandateLinkageLookupType:
   description: ″
   value:
   BY_ACCOUNT_KEY
   BY_MANDATE_KEY
   type: string
AccountReadinessStatus:
   description: “AccountReadinessStatus * ‘UNKNOWN’—is for forward compatibility”
   value:
   UNKNOWN
   COMPLETED
   IN_PROGRESS
   FAILED
   type: string.

Below is a list of non-limiting examples of category of constraints:
categories:

```
  - category: Security SubType and Order Side Restrictions
    template: |
          $order: Order(security.securitySubType in(<SecuritySubTypes>) &&
orderSide in (<OrderSides>) && <AdditionalConditions>)
  - category: Platform and Account Category Restrictions
    template: |
        $order: Order(platform in(<Platforms>) && account.accountCategory
in(<AccountCategories>) && <AdditionalConditions>)
  - category: Client and Firm Restrictions
    template: |
              $order: Order(<OrderConditions>) && exists
<RestrictionType>(restrictionType == <RestrictionType> && restrictionAction in
(<Actions>) && <RestrictionConditions>) from $order.<RestrictionSource>
  - category: Investment Objective and Tax Profile
    template: |
                $order:
Order(account!.investmentObjectiveTypeName.contains(<ObjectiveType>) &&
<AdditionalConditions>)
  - category: API Call Failures
    template: |
      $order: Order(<ApiFailureCondition> == true)
  - category: Helper Function Checks
    template: |
            $order: Order(Helper.<FunctionName>(<Parameters>) &&
<AdditionalConditions>)
  - category: Country Restrictions
    template: |
          $order: Order(security.issuerCountryCode in(<CountryCodes>) &&
<AdditionalConditions>)
  - category: Account Restrictions
    template: |
              $order: Order(account.<AccountCondition> &&
<AdditionalConditions>)
  - category: Legal Restrictions
    template: |
      $order: Order(security.firmRestriction != null && <LegalConditions>).
```

Below is an example of a dialog to convert a natural language input into a DRL rule:
You: Hello
Assistant: Hey there! How's it going?
You: I have new constrain: Buying proprietary money market funds is restricted for fiduciary accounts with tax service codes like “I”, “J”, or “M”.
Assistant:
Structural Constraint:
Platform: USA—Specific platform where the restriction is applied
OrderSide: BUY—Only applies to buy transactions
AccountCategory: FIDUCIARY—Applies to fiduciary accounts
SecuritySubType:
   INT_OMF—Internal Money Market Fund
   IN_HOUSE_MUTUAL_FUNDS—In-house Mutual Funds
HelperMethod: isProprietaryMoneyMarketFund-A method to check if the security is a proprietary money market fund
OtherTaxServiceCode:
   I—Specific tax service code
   J—Specific tax service code
   M—Specific tax service code
RuleAction: ADD_ALERT—Action to add an alert when the constraint is triggered
Description: Buying proprietary money market funds is restricted for fiduciary accounts with tax service codes “I”, “J”, or “M”. This new constraint takes priority over the existing constraint.

### Summary

A new constraint has been created that restricts the buying of proprietary money market funds for fiduciary accounts with specific tax service codes “I”, “J”, or “M”. This new rule takes precedence over any existing rules.

```
What would you like to do next?
You: Generate DRL
Assistant:
## package
package net.jpmchase.ruleit.rules;
## imports
import net.jpmchase.facts.model.Order;
import net.jpmchase.mapi.targetportfolio.model.PtcAccount;
import net.jpmchase.mapi.core.model.SecuritySubType;
import net.jpmchase.ruleit.engine.RuleAlertStore;
import net.jpmchase.mapi.core.model.AccountCategory;
## globals
global RuleAlertStore ruleAlertStore;
global Map<String, RuleLibrary> rules;
## Rule Definition
rule
“PREVENT_FIDUCIARY_TAX_SERVICE_CODE_PROP_MMF”
  when
    $order: Order(
      platform in (Platform.USA) &&
      orderSide == “BUY” &&
      account.accountCategory in (AccountCategory.FIDUCIARY) &&
      security.securitySubType in (SecuritySubType.INT_OMF,
      SecuritySubType.IN_HOUSE_MUTUAL_FUNDS) &&
      Helper.isProprietaryMoneyMarketFund(security) &&
      account.otherTaxServiceCode in (“I”, “J”, “M”)
    )
  then
    ruleAlertStore.addAlert($order, drools.getRule( ).getName( ),
    “ANY”);
    System.out.println(“The rule matches”);
end
```

This DRL (Decision Rule Language) rule is named “PREVENT_FIDUCIARY_TAX_SERVICE_CODE_PROP_MMF”. It checks if the order is placed on the USA platform, is a “BUY” order, the account category is fiduciary, the security subtype is either “INT_OMF” or “IN_HOUSE_MUTUAL_FUNDS”, the security is a proprietary money market fund, and the account's other tax service code is either “I”, “J”, or “M”. If all conditions are met, an alert is added and a message is printed indicating that the rule matches.
You: Verify generated DRL
Assistant:
valid
Would you like to proceed with testing the rule using a specific scenario, or is there anything else you need assistance with?
You: Generate test data for positive and negative test cases
Assistant:

### #Test Data Generation for Rule Verification

### ##Positive Test Case

**Scenario**: Test when all conditions of the rule are met.
   **Platform**: USA
   **OrderSide**: BUY
   **AccountCategory**: FIDUCIARY
   **SecuritySubType**: INT_OMF or IN_HOUSE_MUTUAL_FUNDS
      **Helper Method Return**: True (indicating it is a proprietary money market fund)
   **OtherTaxServiceCode**: “I”, “J”, or “M”
   *Expected Outcome**: The rule should trigger and add an alert.

### ###Example

```
{
  “platform”: “USA”,
  “orderSide”: “BUY”,
  “accountCategory”: “FIDUCIARY”,
  “securitySubType”: “INT_OMF”,
  “isProprietaryMoneyMarketFund”: true,
  “otherTaxServiceCode”: “I”
}
```

### ##Negative Test Case

**Scenario**: Test when one or more conditions of the rule are not met.
   **Platform**: Not USA
   **OrderSide**: SELL
   **AccountCategory**: Not FIDUCIARY
      **SecuritySubType**: Not INT_OMF or IN_HOUSE_MUTUAL_FUNDS
   **Helper Method Return**: False (indicating it is not a proprietary money market fund)
   **OtherTaxServiceCode**: Not “I”, “J”, or “M”
   *Expected Outcome**: The rule should not trigger and no alert should be added.

### ###Example 1

```
{
  “platform”: “EUROPE”,
  “orderSide”: “BUY”,
  “accountCategory”: “FIDUCIARY”,
  “securitySubType”: “INT_OMF”,
  “isProprietaryMoneyMarketFund”: true,
  “otherTaxServiceCode”: “I”
}
```

### ###Example 2

```
{
  “platform”: “USA”,
  “orderSide”: “SELL”,
  “accountCategory”: “FIDUCIARY”,
  “securitySubType”: “INT_OMF”,
  “isProprietaryMoneyMarketFund”: true,
  “otherTaxServiceCode”: “I”
}
```

### ###Example 3

```
{
  “platform”: “USA”,
  “orderSide”: “BUY”,
  “accountCategory”: “FIDUCIARY”,
  “securitySubType”: “INT_OMF”,
  “isProprietaryMoneyMarketFund”: false,
  “otherTaxServiceCode”: “I”
}
```

### ###Example 4

```
{
  “platform”: “USA”,
  “orderSide”: “BUY”,
  “accountCategory”: “FIDUCIARY”,
  “securitySubType”: “INT_OMF”,
  “isProprietaryMoneyMarketFund”: true,
  “otherTaxServiceCode”: “A”
}
```

### Next Steps

Would you like to proceed with testing the rule using these scenarios, or is there anything else you need assistance with?

The foregoing methodology employs a two-stage paradigm to transform natural language inputs into Drools DRL executable code. The first stage involves constraint creation and intent clarification, allowing users to understand and refine their input/intent. The second stage focuses on the generation of DRL executable code from the clarified constraint, ensuring that the rule is accurately represented and correct. This avoids user error from reaching the software creation stage that would increases the computer resource, electrical power and time required for more extensive testing.

The first stage allows users to better understand the constraints they are creating and clarify the business objectives. By transforming a natural language input into a structured representation, users gain insights into how their business logic is interpreted and applied. This objective process reduces user error before the testing and thereby reduces the need for testing and the corresponding drain on computer resources, electrical power, and time.

The second stage involves generating Drools DRL from the structured constraint. The system uses Retrieval-Augmented Generation (RAG) to identify appropriate categories and tailor templates to the constraint requirements, employing recursive template generation to handle complex rule structures efficiently. Again, this objective process reduces user error and thereby reduces the need for testing and the corresponding drain on computer resources, electrical power, and time.

The methodology uniquely extracts references to data model attributes and predefined values during the constraint creation stage, enhancing the user's business understanding and ensuring accuracy in the generated rules. The mapping of structured constraints to DRL templates using advanced language models leverages AI to bridge the gap between user intent and executable code. This bridge allows for error/course correction before reaching the software creation stage, thereby reducing opportunity for errors that could trigger extensive testing.

The methodology includes an interactive feedback loop where users can confirm, correct, or refine the system's understanding of the constraints. This dynamic interaction ensures that the generated rules align closely with the user's intent, dramatically reducing errors and increasing operational efficiency.

The use of recursive templates, guided by Retrieval-Augmented Generation techniques, allows for dynamic and scalable rule generation. This approach supports complex rule structures by allowing templates to include other templates hierarchically, which is particularly innovative in the context of compliance management.

The system provides users with detailed explanations of the generated DRL code, offering insights into the logic and structure behind the rules. This transparency empowers users to make informed decisions about rule acceptance or modification, enhancing usability and trust in the system. Again, this objective process reduces error before testing and thereby reduces the need for testing and the corresponding drain on computer resources, electrical power and time.

The incorporation of RAG to identify categories tailored to constraint requirements ensures that the most suitable templates are used, optimizing the accuracy and relevance of the generated rules.

By integrating these innovative features, the system establishes a unique method for creating Drools DRL from user inputs, combining advanced AI with user-centric design to enhance both precision and usability in compliance management.

In some embodiments as disclosed above in FIGS. 1-6, technical improvements effected by the instant disclosure may include a platform to generate DRL language from natural language constraints in an accurate and efficient manner, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, comprising:
receiving as input a natural language constraint;
extracting components from the input natural language constraint including at least a data model attribute, a predefined value, and a category of the natural language constraint;
first generating, in response to the at least the extracting and based on the extracted components, a structured constraint that includes an explanation of the extracted components;
first prompting a user to provide first feedback on the structured constraint;
in response to at least receiving a first correction instruction responsive to at least the first prompting, returning to the extracting with the first correction instruction;
in response to at least receiving a first confirmation instruction responsive to at least the first prompting, identifying for the structured constraint a corresponding Drools Rule Language (DRL) template from a repository of recursive templates;
second generating a complete DRL template, including populating the DRL template with at least some of the data model attributes and the predefined values as extracted;
displaying the complete DRL template; and
second prompting a user to provide second feedback on the complete DRL template.

2. The method of claim 1, further comprising:
in response to at least receiving a second correction instruction responsive to the second prompting, returning to the extracting with the second correction instruction; and
in response to at least receiving a second confirmation instruction responsive to the second prompting, testing the complete DRL template.

3. The method of claim 1, wherein the first correction instruction includes information about how to change the data model attribute, the predefined value, and/or any examples of usage.

4. The method of claim 1, wherein the recursive templates allow for hierarchical inclusion of other templates.

5. The method of claim 1, further comprising:
mapping the structured constraint to the identified corresponding DRL template using a language model.

6. The method of claim 1, wherein the generating a complete DRL template comprises generating a complete DRL template recursively.

7. The method of claim 1, wherein the displaying the complete DRL template includes displaying an explanation of structure and rationale of components of the DRL template.

8. A system, comprising:
a processor;
a memory storing instructions programmed to cooperate with the processor to cause the processor to perform operations comprising:
receiving as input a natural language constraint;
extracting components from the input natural language constraint including at least a data model attribute, a predefined value, and a category of the natural language constraint;
first generating, in response to the at least the extracting and based on the extracted components, a structured constraint that includes an explanation of the extracted components;
first prompting a user to provide first feedback on the structured constraint;
in response to at least receiving a first correction instruction responsive to at least the first prompting, returning to the extracting with the first correction instruction;
in response to at least receiving a first confirmation instruction responsive to at least the first prompting, identifying for the structured constraint a corresponding Drools Rule Language (DRL) template from a repository of recursive templates;
second generating a complete DRL template, including populating the DRL template with at least some of the data model attributes and the predefined values as extracted;
displaying the complete DRL template; and
second prompting a user to provide second feedback on the complete DRL template.

9. The system of claim 8, the operations further comprising:
in response to at least receiving a second correction instruction responsive to the second prompting, returning to the extracting with the second correction instruction; and
in response to at least receiving a second confirmation instruction responsive to the second prompting, testing the complete DRL template.

10. The system of claim 8, wherein the first correction instruction includes information about how to change the data model attribute, the predefined value, and/or any examples of usage.

11. The system of claim 8, wherein the recursive templates allow for hierarchical inclusion of other templates.

12. The system of claim 8, the operations further comprising:
mapping the structured constraint to the identified corresponding DRL template using a language model.

13. The system of claim 8, wherein the generating a complete DRL template comprises generating a complete DRL template recursively.

14. The system of claim 8, wherein the displaying the complete DRL template includes displaying an explanation of structure and rationale of components of the DRL template.

15. A non-transitory computer readable media storing instructions programmed to cooperate with a processor to cause the processor to perform operations comprising:
receiving as input a natural language constraint;
extracting components from the input natural language constraint including at least a data model attribute, a predefined value, and a category of the natural language constraint;
first generating, in response to the at least the extracting and based on the extracted components, a structured constraint that includes an explanation of the extracted components;
first prompting a user to provide first feedback on the structured constraint;
in response to at least receiving a first correction instruction responsive to at least the first prompting, returning to the extracting with the first correction instruction;
in response to at least receiving a first confirmation instruction responsive to at least the first prompting, identifying for the structured constraint a corresponding Drools Rule Language (DRL) template from a repository of recursive templates;
second generating a complete DRL template, including populating the DRL template with at least some of the data model attributes and the predefined values as extracted;
displaying the complete DRL template; and
second prompting a user to provide second feedback on the complete DRL template.

16. The non-transitory computer readable media of claim 15, the operations further comprising:
in response to at least receiving a second correction instruction responsive to the second prompting, returning to the extracting with the second correction instruction; and
in response to at least receiving a second confirmation instruction responsive to the second prompting, testing the complete DRL template.

17. The non-transitory computer readable media of claim 15, wherein the first correction instruction includes information about how to change the data model attribute, the predefined value, and/or any examples of usage.

18. The non-transitory computer readable media of claim 15, wherein the recursive templates allow for hierarchical inclusion of other templates.

19. The non-transitory computer readable media of claim 15, the operations further comprising:
mapping the structured constraint to the identified corresponding DRL template using a language model.

20. The non-transitory computer readable media of claim 15, wherein the generating a complete DRL template comprises generating a complete DRL template recursively.
